(19) United States
(12) Patent Application Publication
(10) Pub. No.: US 2024/0389131 A1
(43) Pub. Date: Nov. 21, 2024

(54) METHODS, ARCHITECTURES, APPARATUS AND SYSTEMS FOR QUALITY OF SERVICE (QOS) ENFORCEMENT AT THE MEDIA ACCESS CONTROL (MAC) LAYER

(71) Applicant: InterDigital Patent Holdings, Inc., Wilmington, DE (US)

(72) Inventors: Martino Freda, Laval (CA); Tuong Hoang, Montreal (CA); Jaya Rao, Montreal (CA); Oumer Teyeb, Montreal (CA)

(21) Appl. No.: 18/696,144

(22) PCT Filed: Sep. 29, 2022
(86) PCT No.: PCT/US2022/045130

§ 371 Date: Mar. 27, 2024

Related U.S. Application Data
(60) Provisional application No. 63/249,682, filed on Sep. 29, 2021.

(51) Int. Cl. H04W 72/566; H04W 72/1268; H04W 72/40; H04W 72/543

(52) U.S. Cl. CPC H04W 72/566; H04W 72/1268; H04W 72/40; H04W 72/543

(57) ABSTRACT

The disclosure pertains to methods and apparatus for quality of service ((QoS) enforcement at the media access control (MAC) layer and, more particularly, to methods and apparatus for determining priority of sidelink and uplink data transmissions in a network.

### CROSS-REFERENCE TO RELATED APPLICATION

The present application claims the benefit of U.S. Provisional Patent Application No. 63/249,682, filed Sep. 29, 2021, which is incorporated herein by reference.

### FIELD OF THE INVENTION

This disclosure pertains to methods and apparatus for enforcing quality of service at the Media Access Control (MAC) layer. More particularly, this disclosure pertains to methods and apparatus for determining priority of sidelink and uplink data transmissions in a network.

### BACKGROUND

A 3GPP Release 17 study on NR sidelink relay [1] will study the use of both WTRU to network relays and WTRU to WTRU relays based on PC5 (sidelink); and, specifically, focused on study item justification/objectives:

For Release 16, a first version of NR sidelink has been developed and it solely focuses on supporting V2X (Vehicle to Anything) related road safety services. The design aims to provide support for broadcast, groupcast, and unicast communications in both out-of-coverage and in-network coverage scenarios. Furthermore, sidelink-based relaying functionality should be additionally studied in order for sidelink/network coverage extension and power efficiency improvement to be considered for a wider range of applications and services.

Further exploration of coverage extension for sidelink-based communication, is required for WTRU-to-network coverage extension: Uu coverage reachability is necessary for WTRUs to reach a server in a Packet Data Network (PDN) or to reach a counterpart WTRU when out of proximity of the network. However, release-13 solutions for WTRU-to-network relay is limited to EUTRA-based technology, and thus cannot be applied to NR-based system for both NG-RAN and NR-based sidelink communication.

Further exploration of coverage extension for sidelink-based communication, is further required for WTRU-to-WTRU coverage extension: Currently, proximity reachability is limited to single-hop sidelink link, either via EUTRA-based or NR-based sidelink technology. However, that is not sufficient in the scenario where there is no Uu coverage, considering the limited single-hop sidelink coverage.

Overall, sidelink connectivity should be further extended in the NR framework, in order to support the enhanced QoS requirements.

The detailed objectives of the aforementioned Rel17 study item [1] are to study single hop NR sidelink relays as study mechanism(s) with minimum specification impact to support the SA requirements for sidelink-based WTRU-to-network and WTRU-to-WTRU relay, focusing on any of the following aspects (if applicable) for layer-3 relay and layer-2 relay [RAN2]: relay (re-)selection criterion and procedure, relay/Remote WTRU authorization, QoS for relaying functionality, service continuity, security of relayed connection after SA3 has provided its conclusions and impact on user plane protocol stack and control plane procedure, e.g., connection management of relayed connection.

The detailed objectives of the aforementioned Rel17 study item [1] are to further study single hop NR sidelink relays as study mechanism(s) to support upper layer operations of discovery model/procedure for sidelink relaying, assuming no new physical layer channel/signal [RAN2].

The study shall take into account of further input from SA WGs, e.g., SA2 and SA3, for the bullets above (if applicable). It is assumed that WTRU-to-network relay and WTRU-to-WTRU relay use the same relaying solution. Forward compatibility for multi-hop relay support in a future release needs to be taken into account. For layer-2 WTRU-to-network relay, the architecture of end-to-end PDCP and hop-by-hop Radio Link Control (RLC), e.g., as recommended in TR 36.746, is taken as starting point.

### SUMMARY

In one embodiment, a method implemented in a Wireless Transmit/Receive Unit (WTRU), may comprise a step of determining a first priority level of an uplink data transmission based on a priority level of a first uplink logical channel. The method may further comprise a step of determining a second priority level of a sidelink data transmission based on a priority level of a second uplink logical channel, the second uplink logical channel corresponding to a sidelink logical channel associated with the sidelink data transmission. The method may further comprise a step of transmitting one of the sidelink data transmission or the uplink data transmission based on a comparison between the first priority level and the second priority level.

In one embodiment, the method may comprise determining the priority level of the second uplink logical channel, wherein determining the priority level of the second uplink logical channel may comprise determining one or more uplink logical channels associated with the sidelink logical channel; and determining the priority level of the second uplink logical channel based on the determined one or more uplink logical channels.

The priority level of the second uplink logical channel may correspond to a maximum priority level or a minimum priority level among the one or more uplink logical channels.

In response to a priority level of the sidelink logical channel being above a sidelink threshold, the priority level of the second uplink logical channel may correspond to the maximum priority level among the one or more uplink logical channels.

In response to a priority level of the sidelink logical channel being below a sidelink threshold, the priority level of the second uplink logical channel may correspond to the minimum priority level among the one or more uplink logical channels.

The method may comprise a step of determining that the uplink data transmission would overlap with the sidelink data transmission.

The method may comprise a step of determining that the sidelink data transmission from the WTRU corresponds to a layer 2 destination of a remote WTRU.

The sidelink logical channel may be a highest priority sidelink logical channel in the sidelink data transmission or a lowest priority sidelink logical channel in the sidelink data transmission.

The transmitting of one of the sidelink data transmission or the uplink data transmission may comprise transmitting the one which has a higher priority level.

The comparison between the first priority level and the second priority level may be a direct comparison.

The second uplink logical channel may map, from an adaptation layer mapping of the WTRU, to the sidelink logical channel associated with the sidelink data transmission.

The second uplink logical channel may comprise a quality of service (QoS) requirement that maps to the sidelink logical channel associated with the sidelink data transmission.

In an embodiment, a wireless transmit/receive unit (WTRU) comprising a processor, a transceiver unit and a storage unit, may be configured to determine a first priority level of an uplink data transmission based on a priority level of a first uplink logical channel. The WTRU may be further configured to determine a second priority level of a sidelink data transmission based on a priority level of a second uplink logical channel, the second uplink logical channel corresponding to a sidelink logical channel associated with the sidelink data transmission.

The WTRU may be further configured to transmit one of the sidelink data transmission or the uplink data transmission based on a comparison between the first priority level and the second priority level.

The WTRU may be further configured to determine the priority level of the second uplink logical channel, wherein determine the priority level of the second uplink logical channel may comprise determine one or more uplink logical channels associated with the sidelink logical channel; and determine the priority level of the second uplink logical channel based on the determined one or more uplink logical channels.

The priority level of the second uplink logical channel may correspond to a maximum priority level or a minimum priority level among the one or more uplink logical channels.

In response to a priority level of the sidelink logical channel being above a sidelink threshold, the priority level of the second uplink logical channel may correspond to the maximum priority level among the one or more uplink logical channels.

In response to a priority level of the sidelink logical channel being below a sidelink threshold, the priority level of the second uplink logical channel may correspond to the minimum priority level among the one or more uplink logical channels.

The WTRU may be configured to determine that the uplink data transmission would overlap with the sidelink data transmission.

The WTRU may be configured to determine that the sidelink data transmission from the WTRU corresponds to a layer 2 destination of a remote WTRU.

The sidelink logical channel may be a highest priority sidelink logical channel in the sidelink data transmission or a lowest priority sidelink logical channel in the sidelink data transmission.

Transmit one of the sidelink data transmission or the uplink data transmission may comprise transmit the one which has a higher priority level.

The comparison between the first priority level and the second priority level may be a direct comparison.

The second uplink logical channel may map, from an adaptation layer mapping of the WTRU, to the sidelink logical channel associated with the sidelink data transmission.

The second uplink logical channel may comprise a quality of service (QoS) requirement that maps to the sidelink logical channel associated with the sidelink data transmission.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram showing the protocol stack for the user plane for a layer 2 evolved WTRU-to-network relay;

FIG. 3 is a diagram showing the protocol stack for the control plane for a layer 2 evolved WTRU-to-network relay;

FIG. 4 is a diagram illustrating certain drawbacks in 3GPP Rel. 16 network systems relating to channel prioritization with respect to SL and UL channels;

FIG. 5 is a diagram illustrating certain drawbacks in 3GPP Rel. 17 network systems relating to channel prioritization with respect to SL and UL channels; and

FIG. 6 is a flowchart illustrating a channel prioritization method for SL and UL in accordance with an embodiment.

FIG. 7 is a flow chart illustrating an example of a method implemented in a WTRU, for determining whether to prioritize an uplink transmission or a sidelink transmission.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Examples of Networks for Implementation of the Embodiments.

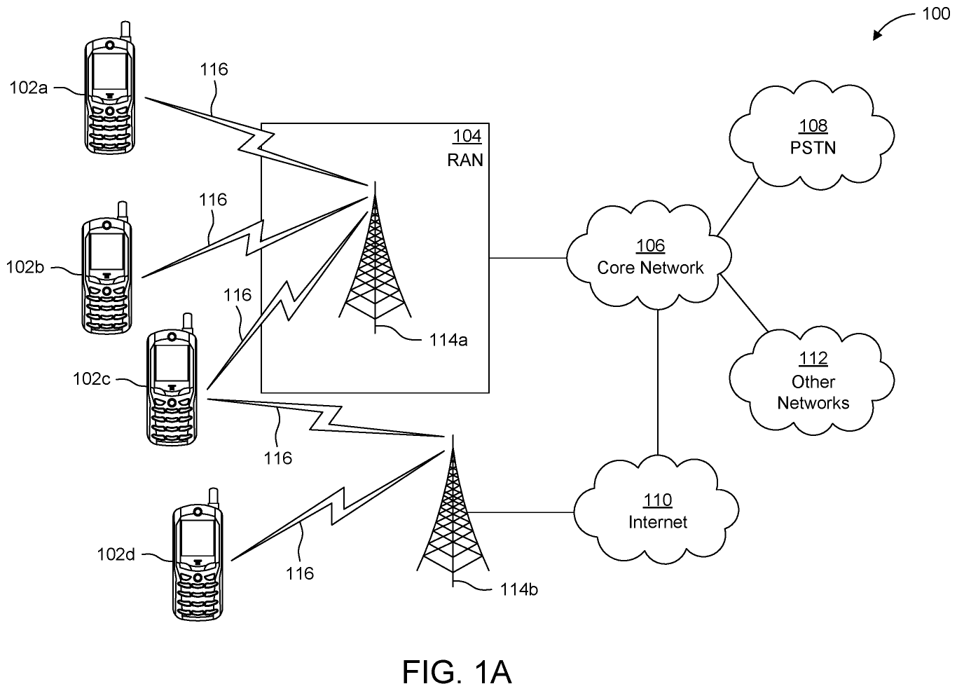

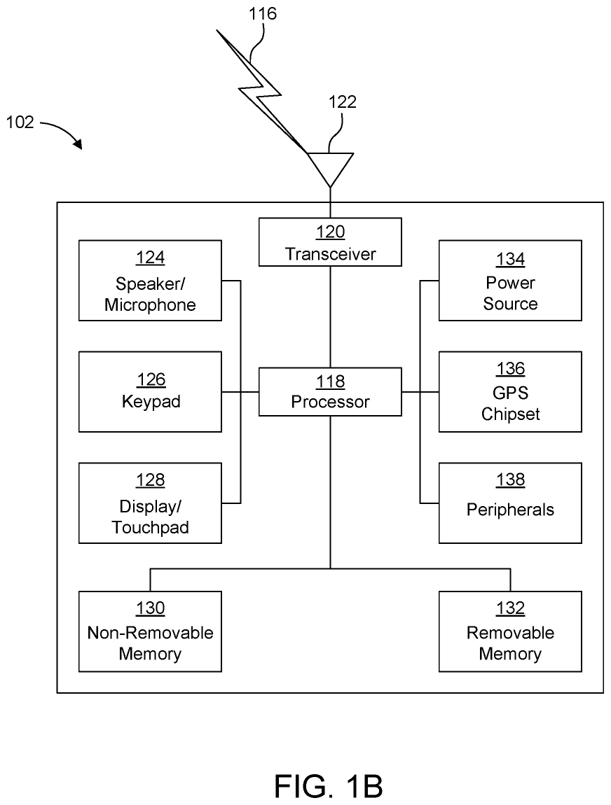

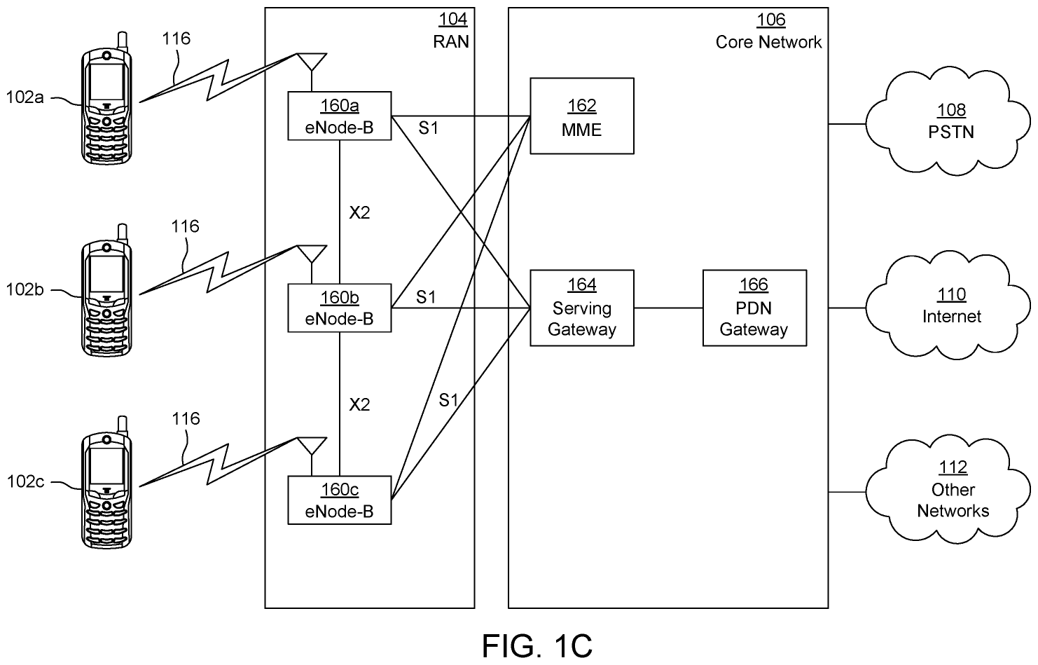

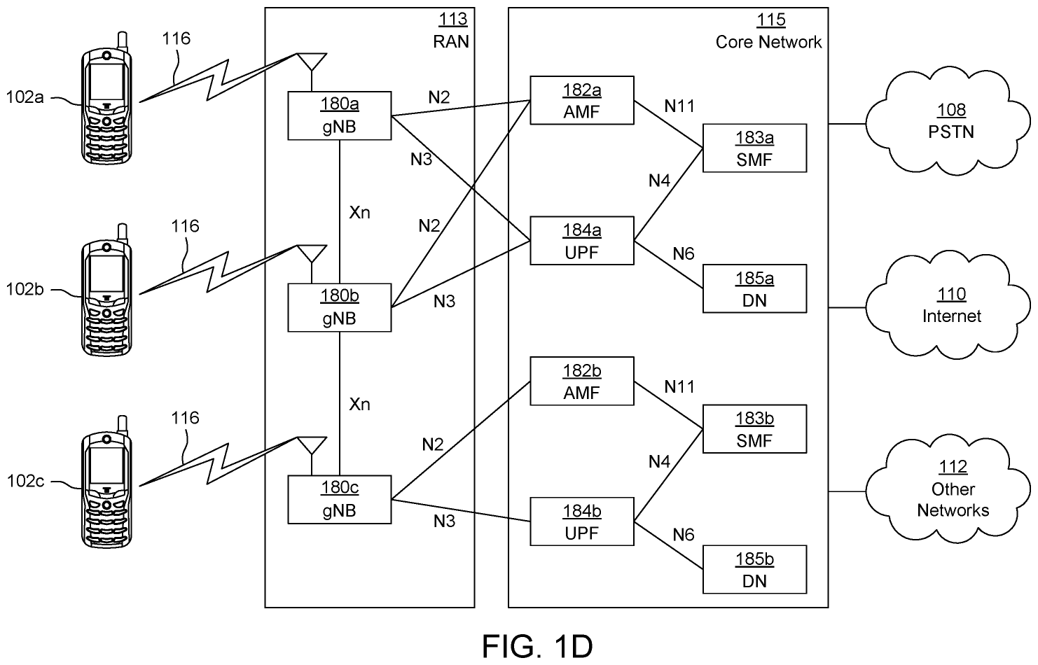

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.1 lac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example of WTRU to Network Relays in Rel-13.

Relaying via ProSe for WTRU to Network relays was introduced in Rel13 to extend network coverage to an out of coverage WTRU by using PC5 (D2D) between an out of coverage WTRU and a WTRU-to-Network relay [2].

Particularly, [2] states in section 23.10.4 “A ProSe WTRU-to-Network Relay provides a generic L3 forwarding function that can relay any type of IP traffic between the Remote WTRU and the network. One-to-one and one-to-many sidelink communications are used between the Remote WTRU(s) and the ProSe WTRU-to-Network Relay. For both Remote WTRU and Relay WTRU only one single carrier (i.e., Public Safety ProSe Carrier) operation is supported (i.e., Uu and PC5 should be same carrier for Relay/Remote WTRU). The Remote WTRU is authorized by upper layers and can be in-coverage of the Public Safety ProSe Carrier or out-of-coverage on any supported carriers including Public Safety ProSe Carrier for WTRU-to-Network Relay discovery, (re)selection and communication. The ProSe WTRU-to-Network Relay is always in-coverage of EUTRAN. The ProSe WTRU-to-Network Relay and the Remote WTRU perform sidelink communication and sidelink discovery as described in section 23.10 and 23.11 respectively.”

### Example of Relay Selection for WTRU to Network Relays.

Relay selection/reselection for ProSe WTRU to network relays is performed based on combination of a AS layer quality measurements (RSRP) and upper layer criteria.

This is described in more detail in section 23.10.4 of the stage 2 specifications, as follows [2]: the eNB controls whether the WTRU can act as a ProSe WTRU-to-Network Relay: if the eNB broadcast any information associated to ProSe WTRU-to-Network Relay operation, then ProSe WTRU-to-Network Relay operation is supported in the cell. The eNB may provide any of transmission resources for ProSe WTRU-to-Network Relay discovery using broadcast signalling for RRC_IDLE state and dedicated signalling for RRC_CONNECTED state and reception resources for ProSe WTRU-to-Network Relay discovery using broadcast signalling. The eNB may broadcasts a minimum and/or a maximum Uu link quality (RSRP) threshold(s) that the ProSe WTRU-to-Network Relay needs to respect before it can initiate a WTRU-to-Network Relay discovery procedure. In RRC_IDLE, when the eNB broadcasts transmission resource pools, the WTRU uses the threshold(s) to autonomously start or stop the WTRU-to-Network Relay discovery procedure. In RRC_CONNECTED, the WTRU uses the threshold(s) to determine if it can indicate to eNB that it is a Relay WTRU and wants to start ProSe WTRU-to-Network Relay discovery.

If the eNB does not broadcast transmission resource pools for ProSe-WTRU-to-Network Relay discovery, then a WTRU can initiate a request for ProSe-WTRU-to-Network Relay discovery resources by dedicated signalling, respecting these broadcasted threshold(s).

If the ProSe-WTRU-to-Network Relay is initiated by broadcast signalling, it can perform ProSe WTRU-to-Network Relay discovery when in RRC_IDLE. If the ProSe WTRU-to-Network Relay is initiated by dedicated signalling, it can perform relay discovery as long as it is in RRC_CONNECTED.

A ProSe WTRU-to-Network Relay performing sidelink communication for ProSe WTRU-to-Network Relay operation has to be in RRC_CONNECTED. After receiving a layer-2 link establishment request or TMGI (Temporary Mobile Group Identity) monitoring request (upper layer message) from the Remote WTRU, the ProSe WTRU-to-Network Relay indicates to the eNB that it is a ProSe WTRU-to-Network Relay and intends to perform ProSe WTRU-to-Network Relay sidelink communication. The eNB may provide resources for ProSe WTRU-to-Network Relay communication.

The remote WTRU can decide when to start monitoring for ProSe WTRU-to-Network Relay discovery. The Remote WTRU can transmit ProSe WTRU-to-Network Relay discovery solicitation messages while in RRC_IDLE or in RRC_CONNECTED depending on the configuration of resources for ProSe WTRU-to-Network Relay discovery. The eNB may broadcast a threshold, which is used by the Remote WTRU to determine if it can transmit ProSe WTRU-to-Network Relay discovery solicitation messages, to connect or communicate with a ProSe WTRU-to-Network Relay WTRU. The RRC_CONNECTED Remote WTRU uses the broadcasted threshold to determine if it can indicate to the eNB that it is a Remote WTRU and wants to participate in ProSe WTRU-to-Network Relay discovery and/or communication. The eNB may provide transmission resources using broadcast or dedicated signaling and reception resources using broadcast signaling for ProSe WTRU-to-Network Relay Operation. The Remote WTRU stops using ProSe WTRU-to-Network Relay discovery and communication resources when RSRP goes above the broadcasted threshold (note that the exact time of traffic switching from Uu to PC5 or vice versa is determined in a higher layer).

The Remote WTRU performs radio measurements at the PC5 interface and uses them for ProSe WTRU-to-Network Relay selection and reselection along with higher layer criterion. A ProSe WTRU-to-Network Relay is considered suitable in terms of radio criteria if the PC5 link quality exceeds a configured threshold (pre-configured or provided by an eNB). The Remote WTRU selects the ProSe WTRU-to-Network Relay that satisfies higher layer criterion and has the best PC5 link quality among all suitable ProSe WTRU-to-Network Relays.

The Remote WTRU triggers ProSe WTRU-to-Network Relay reselection when PC5 signal strength of current ProSe WTRU-to-Network Relay is below a configured signal strength threshold. It receives a layer-2 link release message (upper layer message) from ProSe WTRU-to-Network Relay.

### Example of WTRU to Network Relays for Wearables.

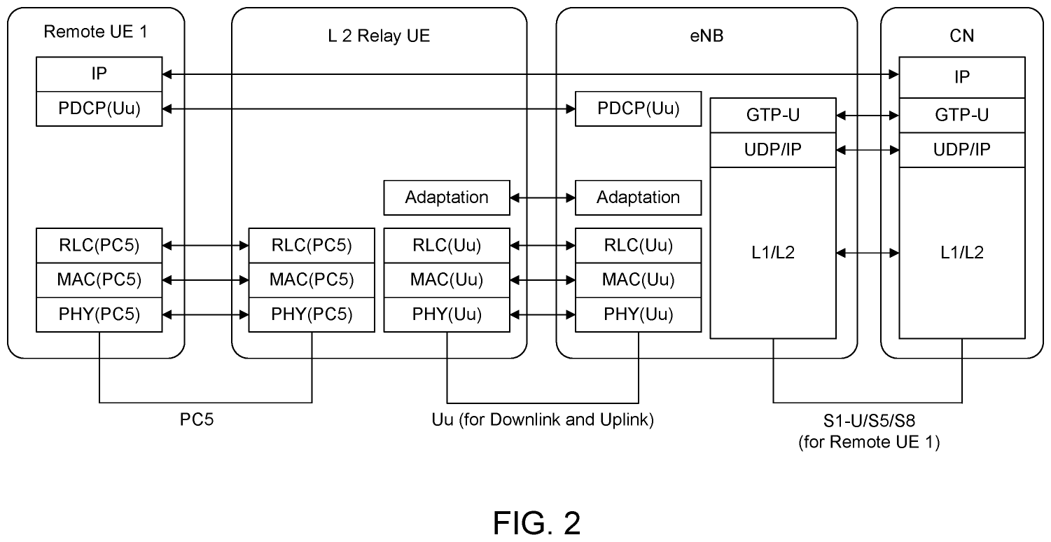

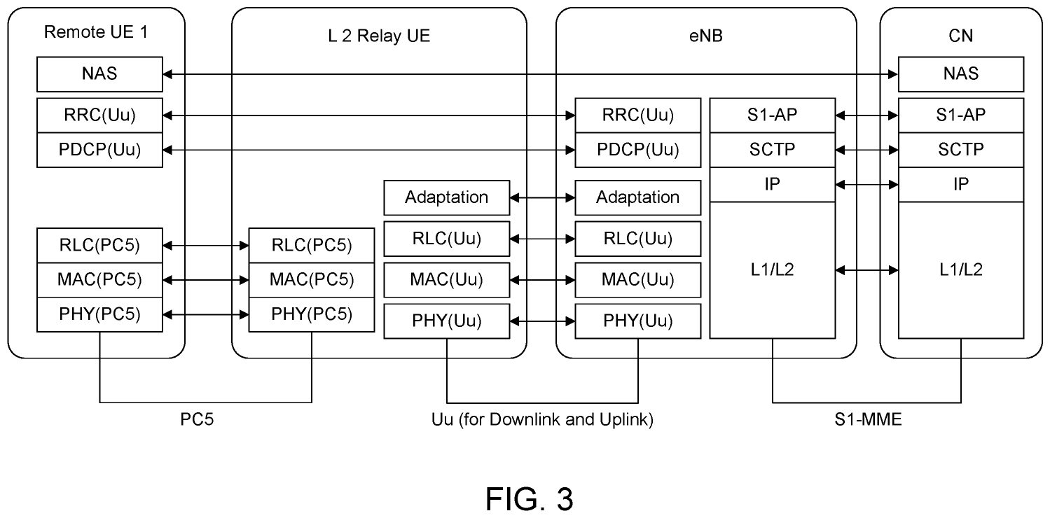

In release 14, a study for WTRU to network relays for commercial use cases tailored to wearables and IoT devices was performed in RAN [3]. While such study did not result in any specification, a technical report (TR) provided some preferred solutions for such relays. Contrary to ProSe WTRU to network relays, which use a L3 (IP layer) relaying approach, the WTRU to network relays for wearables was expected to be a L2 relay based on the protocol stacks shown in FIGS. 2 and 3, wherein FIG. 2 shows the protocol stack for the user plan and FIG. 3 shows the protocol stack for the control plane for a layer 2 evolved WTRU-to-network relay (PC5).

### Example of Connection Establishment for Unicast Links in NR V2X.

Relay solutions in previous releases of the LTE specification were based on a one to one communication link established at upper layers (ProSe layer) between two WTRUs (the remote WTRU and WTRU to network relay). Such connection was transparent to the AS (Access Stratum) layer and connection management signaling and procedures performed at the upper layers was carried by AS layer data channels. The AS layer is therefore unaware of such a one to one connection.

In NR V2X (Rel16), the AS layer supports the notion of a unicast link between two WTRUs. Such unicast link is initiated by upper layers (as in the ProSe one-to-one connection). However, the AS layer is informed of the presence of such unicast link and any data that is transmitted in unicast fashion between the peer WTRUs. With such knowledge, the AS layer can support HARQ feedback, CQI feedback, and power control schemes which are specific to unicast.

A unicast link at the AS layer is supported via a PC5-RRC connection. In [4], the PC5-RRC connection is defined as follows: the PC5-RRC connection is a logical connection between a pair of a Source Layer-2 ID and a Destination Layer-2 ID in the AS. One PC5-RRC connection is corresponding to one PC5 unicast link [xx]. The PC5-RRC signaling, as specified in sub-clause 5.X.9, can be initiated after its corresponding PC5 unicast link establishment. The PC5-RRC connection and the corresponding sidelink SRBs and sidelink DRBs are released when the PC5 unicast link is released as indicated by upper layers. For each PC5-RRC connection of unicast, one sidelink SRB is used to transmit the PC5-S messages before the PC5-S security has been established. One sidelink SRB is used to transmit the PC5-S messages to establish the PC5-S security. One sidelink SRB is used to transmit the PC5-S messages after the PC5-S security has been established, which is protected. One sidelink SRB is used to transmit the PC5-RRC signaling, which is protected and only sent after the PC5-S security has been established.

PC5-RRC signaling includes a sidelink configuration message (RRCReconfigurationSidelink), where one WTRU configures the RX-related parameters of each SLRB (Sidelink Radio Bearer) in the peer WTRU. Such reconfiguration message can configure the parameters of each protocol in the L2 stack (SDAP, PDCP, etc.). The receiving WTRU can confirm or reject such configuration, depending on whether it can support the configuration suggested by the peer WTRU.

Comparison of priority of logical channels is an operation performed often by WTRUs, for example, when performing LCP (Logical Channel Prioritization) for UL transmission. In the case of Sidelink (SL), in addition to LCP, the WTRU also performs priority comparison to determine whether to prioritize an UL or SL transmission when both transmissions cannot be performed simultaneously. Following discussion in Rel16 NR V2X, it was agreed that UL and SL traffic cannot be compared directly by comparing the configured UL and SL priorities directly. Instead, comparison of UL and SL priorities (for determining whether to transmit UL or SL when the grants conflict) is performed with separate UL and SL priorities. For example, mapping from PQI to SL priority may not follow the same rules as mapping 5QI (5G QoS Identifier) to Uu priority. Also, the range of SL priorities (1-8) does not match the range of Uu priorities (1-16).

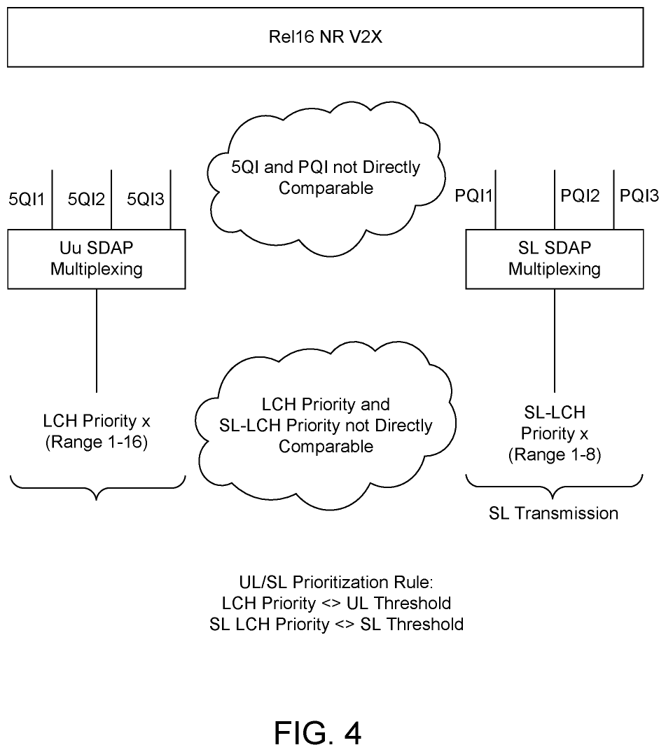

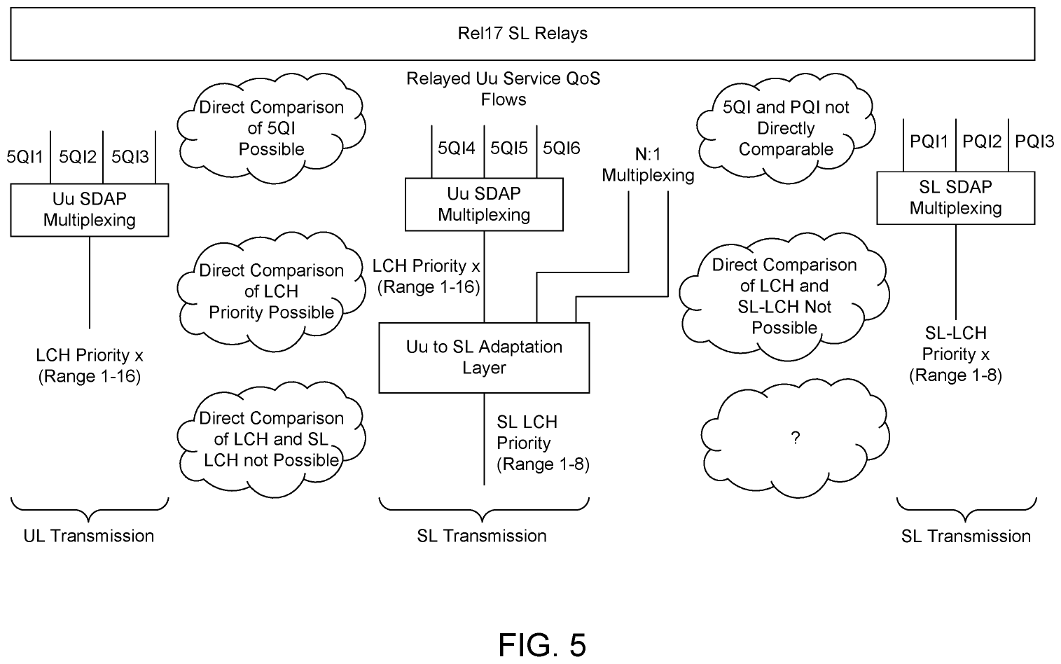

For a WTRU to network relay, SL transmissions can either be normal SL transmissions (initiated by SL services at the relay WTRU itself) or can be relayed Uu traffic. In such case, prioritization between UL transmissions and SL transmissions when the SL transmissions consist of Uu traffic should be revisited, give that such Uu traffic may be associated with a Uu priority on the Uu link. Similarly, comparison of SL traffic over SL and relayed Uu traffic over SL (e.g. for operations such as SL destination selection in LCP) may need to be reconsidered considering that the Uu traffic priority may not be well represented by the SL LCH (Logical Channel) priority. FIGS. 4 and 5 illustrates the nature of the problem in Rel 16 and Rel. 17, respectively.

Furthermore, a SL WTRU in mode 1 will trigger SL BSR (Buffer Status Report) to inform the network of the buffer status associated with sidelink transmissions. For a WTRU to network relay in mode 1, SL transmissions can correspond to relayed Uu traffic received from the gNB. For that reason, SL BSR may not always be required. The same can be said about multihop relays or WTRU-to-WTRU relays, in that there may be situations where reporting BSR to the network may be redundant and not necessary. SL BSR triggers and computation procedure should therefore be revisited to take these cases into account to avoid unnecessary scheduling/granting of UL resources (e.g., due to a redundant SL BSR triggered in relation relayed Uu data).

Moreover, for a WTRU to network relay, end to end Uu QoS parameters such as Packet Data Budget (PDB), Packet Error Rate (PER), etc. need to be split by the gNB so that these parameters can be applied over each of the SL and Uu links. While it would be possible to have a static split, conditions on the SL and Uu may change dynamically, and thus it is beneficial to update the split upon change of the radio quality and congestion conditions on both links. However, if the network needs to update the split with RRC signaling each time a condition changes (and send such signaling to both the remote and relay WTRU), it would cause significant signaling overhead. Additionally, the response by the network may not be timely as the conditions on both links could change very fast.

### Enhancements to QoS Enforcement.

In the following discussion, methods for prioritization between SL and UL data or traffic are disclosed in the context of relaying. In such discussion, SL and UL data or transmissions refer to transmissions made by a WTRU over the SL and Uu link, respectively. On the other hand, SL or UL traffic refers to whether the service associated with the transmission is a SL or UL service. Specifically, a WTRU may perform SL transmissions of Uu traffic in the context of a SL WTRU to network relay. In that case, the solutions below refer to such transmissions as Uu traffic transmitted over SL, or SL data containing Uu traffic.

Example of Actions/Operations which May be Affected by Prioritization Rules.

Methods for prioritization of traffic described herein may be used for determining the mechanism or results of any of the following operations at the WTRU. An operation may consist of SL destination selection during LCP. Specifically, the WTRU may use such prioritization rule to select the SL destination L2 ID(s) for transmission within a SL grant.

Another operation may consist of LCH selection during LCP. Specifically, the WTRU may use such prioritization rule to select the SL LCH to be multiplexed within a SL grant. Specifically, the WTRU may use such prioritization rule to select between a MAC CE or a LCH when multiplexing data into a SL grant.

Another operation may consist of prioritization between SL BSR and Uu BSR when including both SL BSR and Uu BSR in an UL grant.

Another operation may consist of prioritization between UL and SL grants. Specifically, the WTRU may use such prioritization rule for determining whether to prioritize between an UL and a SL grant, for example, if the WTRU can only transmit one of the grants and must drop the other grant.

Another operation may consist of determining whether to trigger indication/transmission to the network, such as, but not limited to, SR (Scheduling Request), BSR, assistance information, etc. For example, a WTRU may trigger an SR when data arrives for a logical channel whose priority is greater than the priority of any pending data at the WTRU. Determination of or comparison of such priority may use any of the rules described herein.

Another operation may consist of determining whether to trigger mode 2 resource and/or carrier (re)selection. For example, a WTRU may determine whether mode 2 resource and/or carrier (re)selection is triggered depending on the results of a prioritization determination/rule.

Another operation may consist of determining a property associated with mode 2 resource selection. For example, a WTRU may use the results of any prioritization determination/rule described herein to determine any of the value of a sensing parameter (e.g. occupancy threshold, percentage of available resources indicating successful sensing, parameter defining the number of resources to be sensed prior to resource selection, etc.) and the mechanism of sensing to be applied (e.g. use partial sensing, full sensing, random selection)

Another operation may consist of determining the resource pool to be used for transmission. For example, a WTRU may select a resource pool for transmission depending on any of the prioritization rules herein.

### Examples of Methods for Deriving the Priority Value of a SL Transmission Carrying Relayed Uu Data.

For the purposes of comparison of priorities (e.g. between SL and SL, or between UL and SL) for the actions described herein, the WTRU may need to derive a priority value associated with a SL transmission containing relayed data. Any of the below embodiments for deriving the priority can be considered as part of a technique that requires determining a priority associated with a SL transmission carrying relayed data.

### Example of Deriving the Priority of a SL Transmission Containing Relayed Traffic Based on Adaptation Layer Mapping.

An adaptation layer has been introduced for SL relays, where such adaptation layer is configured (by the network) with a mapping between the Uu LCHs and the SL LCHs. In one embodiment, the WTRU may derive the priority based on the mapping of Uu LCH priorities to the SL LCH(s) associated with the transmission. Specifically, the WTRU may determine the SL LCH(s) included in the transmission and obtain the associated Uu LCHs that can be mapped to the SL LCH(s). The WTRU may then use a priority derived from one of the Uu LCH(s).

A WTRU may first determine one or more SL LCH(s) included in the SL transmission.

In one family of embodiments, the WTRU may first determine a single SL RLC channel associated with the transmission. The single SL RLC channel may be the highest SL priority SL RLC channel for which data is multiplexed in the SL transmission. Alternatively, the single SL RLC channel may be the lowest priority SL priority SL RLC channel for which data is multiplexed in the SL transmission. Alternatively, the single SL RLC channel may be one of the SL RLC channels multiplexed into the SL transmission for which the priority may be a median, average, mean, etc. operation of the set of SL priorities associated with the SL RLC channels having data multiplexed into the grant. Without loss of generality, other factors described herein may be used to select between the options within this family (e.g., selecting one SL RLC channel over another SL RLC channel depending on other factors described herein). In such a family of embodiments, the priority of the SL transmission may be derived from the priorities of the Uu RLC channels that are mapped to this single SL RLC channel.

In another family of embodiments, the WTRU may determine multiple SL RLC channels for consideration. The multiple SL RLC channels may be all of the SL RLC channels for which data was included in the SL transmission. The multiple SL RLC channels may comprise the highest priority SL RLC channels for which data was included in the SL transmission. Alternately, the multiple SL RLC channels may comprise the lowest priority SL RLC channels for which data was included in the SL transmission. Alternately, the multiple SL RLC channels may comprise all the SL RLC channels with SL priority above/below a configured threshold for which data was included in the SL transmission. In such a family of embodiments, the priority of the SL transmission may be derived from the priorities of the Uu RLC channels that are mapped/can be mapped to these multiple SL RLC channels.

A WTRU may then determine the Uu RLC channels which can be mapped (e.g., in the adaptation layer configuration/mapping) to the one or more SL RLC channels above.

In one family of embodiments, the WTRU may select a single Uu RLC channel based on priority and use the priority configured for that Uu RLC channel. The WTRU may select the Uu RLC channel with the highest priority, lowest priority, median/average priority, etc. The WTRU may use other factors described herein to determine which Uu RLC channel to use to derive the priority.

In another family of embodiments, the WTRU may compute a priority from the priority of one or more selected Uu RLC channel priorities. The WTRU may compute an average priority value. The WTRU may select one Uu RLC channel, and derive the priority by adding a value, offset, of conversion to that priority, as described further herein.

### Example of Deriving the Priority of a SL Transmission Containing Relayed Traffic Based on Mapped Uu QoS Flows.

In another solution, the WTRU may derive the priority based on information about the Uu QoS flows/requirements that can be carried by/mapped to the SL LCH. Specifically, the WTRU may receive, (e.g., in the adaptation layer header) information that can be used to derive a priority based on the end to end QoS flow(s) or bearers included in the transmission or mapped to the RLC channels included in the transmission.
In one solution, the WTRU may receive a Uu bearer ID in the adaptation layer header. The WTRU may further be configured with a mapping (e.g., in dedicated RRC signaling) of Uu bearer ID to equivalent Uu priority. The priority may correspond to an equivalent non-relayed priority. The WTRU may use the equivalent Uu priority as the SL transmission priority for comparison (e.g., for UL/SL prioritization, or SL/SL comparison, as described herein)
In another solution, the WTRU may receive the QoS flow ID(s) in the adaptation layer header. The WTRU may further be configured with a mapping (e.g., in dedicated RRC signaling) of the QoS flow IDs to equivalent Uu priority.

### Example of Deriving the Priority of a SL Transmission Containing Relayed Traffic Based on QoS Information in a Transmission.

In another embodiment, the WTRU may derive the priority based on QoS information included with the SL transmission (e.g., in the adaptation layer header). In another solution, the WTRU may receive a QoS requirements (5QI, etc.). The WTRU may derive an equivalent Uu priority based on a configured mapping (similar to the previous solution). Alternatively, the WTRU may derive an equivalent mapping based on a similar mapping of PQI to LCH priority configured for another bearer at the WTRU (e.g., a non-relayed Uu bearer).

### Examples of Comparison of SL and SL Transmissions

Example of Comparison Between SL Traffic May Use a Different Method than Direct Priority Order.

Prioritization between logical channels is generally performed by comparing the LCH priority. In one mechanism, a WTRU may use a different method than direct priority value comparison when performing any of the actions/operations above. Such different method may be applied to comparison between any of the following data/LCHs: when comparing data to be relayed with data which is not relayed, when comparing SL transmissions carrying Uu traffic versus SL traffic, when comparing data to be relayed by a different total number of hops, and when comparing data to be relayed which has a different number of hops remaining until its destination.

Methods for comparison between these data and/or LCHs may use any of the following techniques: application of an offset, increase, decrease, or compensation in priority based on a factor, comparison of the priority of each data/LCH to different thresholds, and using direct comparison

More particularly, application of an offset, increase, decrease, or compensation in priority may be based on a factor such as hop number. For example, the WTRU may apply an offset or compensation to the priority of data when the hop number or remaining number of hops of that data is larger than a configured threshold, or may apply an offset specific to the difference in the number of hops remaining between the data being compared. For example, the WTRU may perform direct comparison of the offsets when the number of hops remaining for the data being compared is the same, or within a configured threshold, and may perform a different comparison (which could use a method described herein).

More particularly, application of an offset, increase, decrease, or compensation in priority may be further based on a factor such as CBR (Channel Busy Ratio). For example, the WTRU may apply an offset to the priority of data (i.e., increase the priority) when the CBR is above a threshold, and may not increase the priority otherwise. Such increase in priority may further be applied when comparing two destinations/LCHs for which the number of hops is not equal, for example.

According to one embodiment comprising comparison of the priority of each data/LCH to different thresholds, the WTRU may be configured with different thresholds (e.g., one applied to Uu traffic and one applied to SL traffic). For example, when performing LCP, the WTRU may select a UL/SL traffic first based on conditions related to whether the UL traffic is above a first threshold and/or the SL traffic is below a second threshold. If the conditions for prioritization based on these thresholds is not satisfied, the WTRU may perform direct comparison. For example, the WTRU may prioritize UL traffic if the UL traffic priority is above a threshold. If it is below a threshold, the WTRU may still prioritize the UL traffic if the SL traffic is below another threshold. If neither of these conditions is met, the WTRU may directly compare the priorities when determining a destination or logical channel to select during LCP, or may prioritize one of the two (e.g., UL traffic) by default, or may prioritize the traffic that has the larger number of hops.

According to one embodiment comprising using direct comparison, when comparing two SL LCHs, if the LCHs both carry SL traffic, the WTRU may use direct priority comparison. If only one of the two LCHs carry Uu traffic, the WTRU may use one of the methods described herein for comparison between SL traffic and Uu traffic. If both SL LCHs carry Uu traffic, the WTRU may use one of the methods described herein for comparison between Uu and Uu traffic relayed over SL.

### Example of Comparison of SL Traffic and Uu Traffic Relayed Over SL.

When prioritizing between SL traffic and Uu traffic over SL, a WTRU may determine which to prioritize using any of the following information, or a combination of the following information, possibly associated with either of the SL traffic or the Uu traffic or both.

The SL priority associated with the SL RLC channel carrying either SL or Uu traffic; the Uu priority of the Uu RLC channels mapped to the SL RLC channel that carries Uu traffic.

A priority offset applied to the SL RLC channel priority when the SL RLC channel contains relayed data: such offset may further be configured based on other factors herein, such as number of hops, number of remaining hops, SL CBR, etc.

The total number of hops associated with the SL traffic and/or the Uu traffic.

The remaining number of hops associated with the SL traffic and/or the Uu traffic.

A metric associated with QoS or remaining QoS, possibly provided by the adaptation layer with each PDU, or statically for a set of PDUs: for example, such metric may be the remaining time to live associated with a PDU, which represents the amount of time until the PDU exceeds its latency budget, for other example, any of the configured thresholds described in embodiments herein above related to priority may be configured for each range of remaining time to live associated with a PDU.

Measurements of the SL channel (e.g. CBR, RSRP, CSI, etc.), for example, any of the configured thresholds described in solutions related to priority may be configured per CBR, RSRP, CSI, etc;

Whether the prioritization is being performed by the remote WTRU or the relay WTRU, for example, the WTRU may be configured with different conditions, rules, or parameters for remote WTRU compared to relayed WTRU.

Whether the prioritization involves UL Uu data or DL Uu data, for example, the WTRU may be configured with different conditions, rules, or parameters for UL Uu data compared to DL Uu data.

### Examples of SL Destination Selection During LCP Procedure.

The following exemplary embodiments describe SL destination selection during LCP procedure. However, the decision criteria may be used for any other prioritization decision described herein. In addition, multiple of the following exemplary embodiments may be used in combination for prioritization. Specifically, for example, the WTRU may use a first example when a specific condition is satisfied, and may use another when the condition is not satisfied. Alternatively, the WTRU may use a first example for selecting between destination IDs, and use second example when selecting between LCHs transmitted to the same destination ID.

In one example, the WTRU may be configured with a Uu priority threshold for prioritizing Uu traffic. A WTRU may select a SL destination with Uu traffic over a SL destination with SL traffic if one of the SL RLC channels with data available for transmission to that SL destination (and exceeding the prioritized bit rate—i.e. bj>0) contains Uu traffic where the Uu priority of at least one Uu RLC channel mapped to the SL RLC channel by the adaptation layer is above the configured Uu priority threshold. If not, the WTRU may determine whether to select the SL destination with SL traffic or the SL destination with Uu traffic based on other embodiments described herein.

In another example, the WTRU may be configured with a SL priority threshold for prioritizing Uu traffic. For instance, a WTRU may select a SL destination with SL traffic over a SL destination with Uu traffic if one of the SL RLC channels with SL traffic available for transmission (and exceeding the prioritized bit rate) contains data above the SL priority threshold.

In another example, the WTRU may be configured with a SL RLC priority offset. The WTRU may apply such offset when comparing the priority of a SL RLC channel carrying Uu traffic and a SL RLC channel carrying SL traffic. The WTRU, when selecting the destination for LCP, may select the destination with the highest priority LCH with data available, after the priority offset has been applied to all SL RLC channels carrying Uu traffic.

In another example, the WTRU may be configured with a threshold remaining time to live. If the actual remaining time to live associated with a PDU or the data in a PDU is below a threshold, the WTRU may prioritize the destination associated with such PDU.

In another example, the WTRU may be configured with a CBR threshold. If the measured CBR is above a threshold, the WTRU may use a first rule for prioritizing between an SL destination with Uu traffic and an SL destination with SL traffic, and when the CBR is below a threshold, the WTRU may use a second rule.

In another example potentially applicable to cases where other criteria are equal/not satisfied, the WTRU may prioritize relayed traffic over non-related traffic. Specifically, it may select the SL destination with Uu traffic over the SL destination with SL traffic.

Example of Further Considerations when SL Destination/LCH can Contain Both SL and Uu Traffic.

A SL destination and/or LCH may contain Uu traffic relayed via sidelink as well as SL traffic. This traffic may be contained within a LCH, or in a destination having data available for different LCHs (LCHs containing SL traffic and LCHs containing Uu traffic).

In such a scenario, the WTRU may be configured with rules to select between a SL destination containing only SL traffic, a SL destination containing only Uu traffic, and a SL destination containing both SL traffic and Uu traffic. Such rules may be applicable to destinations that are allowed to transmit SL traffic only, destinations that are allowed to transmit Uu traffic only, and/or destinations that are allowed to transmit both. Alternatively or additionally, similar rules may be applied to destinations that are allowed to transmit both, but the rules are applied between destinations that have only SL traffic available for transmissions (or which exceed the PBR), destinations that have only Uu traffic available for transmission (or which exceed the PBR), and destinations that have both SL traffic and Uu traffic available for transmissions (or which exceed the PBR).

In all of these scenarios, any of the following embodiments may be implemented.

In one embodiment, WTRU may be configured to prioritize destinations based on the allowable or available traffic types. For example, a destination having both available channel types (Uu and SL) may be prioritized over a destination having only one channel type. Such may be applied if the same priority is determined for the two destinations, of it the two destinations have priorities within a specific range of each other.

In one embodiment, both SL priority (e.g., direct comparison) or Uu priority (e.g., threshold based comparison) may be used, and, if either comparison results in the destination that supports relayed traffic being prioritized, the WTRU may select the destination that supports relayed traffic. Otherwise, the non-relayed destination may be selected.

In one embodiment, either Uu priority (e.g., direct comparison) or SL priority (e.g., threshold based comparison) may be used, and if the comparison results in the destination that supports relayed traffic being prioritized, the WTRU may select the destination that supports relayed traffic. Otherwise, the destination supporting both traffic may be selected

Example of Comparison of Uu Traffic and Uu Traffic, Both being Relayed Over SL.

The WTRU may select between two different Uu traffics relayed over SL. The WTRU may use any of the following for the selection/prioritization between such SL transmissions: direct comparison of the SL LCH priority, comparison of the Uu RLC channels mapped to the SL RLC channel by the adaptation layer, and the number of remaining and/or total number of hops being used for relaying.

For example, in case of direct comparison of the SL LCH priority, the WTRU may perform comparison of two (or more) SL destinations wherein both carry Uu traffic by direct comparison of the SL RLC channel priorities only. In some embodiments, this scheme may be employed in only a subset of cases. For example, such direct comparison may be performed only if the number of remaining hops to the destination for the Uu traffic is the same.

For example, in case of comparison of the Uu RLC channels mapped to the SL RLC channel by the adaptation layer, the WTRU may compare the priority of the highest priority Uu RLC LCH mapped to the SL RLC channel LCHs which are being compared, and may select the destination that maximizes the Uu RLC LCH priority. In another example, the WTRU may compare the priority of the lowest priority Uu RLC LCH mapped to the SL RLC channel LCHs being compared, and may select the destination that maximizes the Uu RLC channel LCH priority. In yet another example, the WTRU may compare the priority of the average priority Uu RLC LCH mapped to the SL RLC channel LCHs being compared, and may select the destination which maximized the average priority. In a further example, the WTRU may compare the priority of the highest priority Uu RLC LCH mapped to the SL RLC channel LCHs being compared and which contributed to data available in the buffers at the SL RLC channel, and may select the destination that maximized the Uu RLC LCH priority. In yet a further example, the WTRU may use Uu RLC channel priority comparison instead of SL RLC channel priority comparison if the number of different Uu RLC channel priorities mapped to the SL RLC channel is above/below a threshold, and use SL RLC channel priority comparison otherwise. In some embodiments, these schemes may be employed in only a subset of cases. For example, such direct comparison may be performed only if the number of remaining hops to the destination for the Uu traffic is the same

### EXAMPLE EMBODIMENTS

In one example embodiment, the WTRU may increase the priority associated with SL transmissions with a larger number of remaining hops when the CBR is above a threshold. Specifically, the WTRU may derive the priority of a SL transmission associated with relayed Uu traffic using methods described herein. When comparing the priority of two different SL transmissions (whether the SL transmissions include Uu transmissions or not), the WTRU may consider the remaining number of hops in the transmission. If the CBR is above a threshold, the WTRU may prioritize transmissions that are associated with a larger number of hops. For example, when the CBR is above a threshold, the WTRU may apply a priority offset (e.g., increase the priority by some value) when comparing SL transmissions with a different number of hops. Alternatively, in the case of equal priority, the WTRU may prioritize transmission with a larger number of hops remaining when CBR is above a threshold. Alternatively, the WTRU may apply a priority offset to a transmission, where such priority offset is configured based on the remaining number of hops, and may be applied only when the CBR is above a threshold.

### Examples of Comparison of SL and UL Transmissions.

Direct Comparison is Applied when the SL Data is Relayed UL Traffic.

In one embodiment, comparison between SL and UL (e.g., for the purposes of UL/SL prioritization applied in legacy systems), the WTRU may first determine whether the SL data is relaying UL traffic. If the WTRU is not relaying UL traffic on the SL data, the WTRU may use the SL/UL comparison rule from legacy operation (i.e., comparison based on separate UL threshold and SL threshold). Specifically, the WTRU prioritized UL traffic (a) if the priority of the UL traffic is above a first threshold or (b) if both the UL traffic is below a first threshold and the SL traffic is below a second threshold. On the other hand, if the SL data carries Uu traffic, the WTRU may directly compare the priority of the UL data with a Uu priority associated with the SL data.

Specifically, the Uu priority of the SL traffic can be derived by any of the methods described herein in previous sections. For example, such priority may be derived by the priority of the Uu RLC channels mapped to the highest priority SL LCH (of the priorities included in the SL transmission) in the adaptation layer. Specifically, the WTRU may derive the priority of the Uu traffic (associated with the SL data) that is used to compare with the UL transmissions as any of the following examples.

As one example, the Uu priority may be the highest priority Uu RLC channel that is mapped, in the adaptation layer configuration, to the SL RLC channel to which it is being compared.

As another example, the Uu priority may be the lowest priority Uu RLC channel that is mapped, in the adaptation layer configuration, to the SL RLC channel to which it is being compared.

As another example, the Uu priority may be the average Uu RLC channel priority of the Uu RLC channels mapped, in the adaptation layer configuration, to the SL RLC channel to which they are being compared.

In the examples above, the Uu priority selected for use in the comparison may be the highest priority mapped Uu RLC channel in some embodiments, and the lowest priority in other embodiments. Which priority level is selected may depend on any one or more of the value of the highest/lowest priority, the CBR of the SL data, the number of hops or remaining hops of the relayed data, a time to live parameter associated with the relayed data, the relation between the Uu priority and the SL priority, a parameter in the LCH configuration, etc.

For example, the WTRU may use as the Uu priority, the highest priority if the highest priority is above a threshold, and may use the lowest priority otherwise.

In another example, the WTRU may use as the Uu priority, the highest priority if the number of hops is larger than a threshold, and may use the lowest priority otherwise

In yet another example, the WTRU may use as the Uu priority, the highest priority if the time to live of any/all data associated with the relayed data is below a threshold, and may use the lowest priority otherwise.

In a further example, the WTRU may use as the Uu priority, the highest priority if the SL priority is above a configured threshold associated with the highest/lowest Uu priority mapped to the SL LCH, and may use the lowest Uu priority otherwise.

In yet a further example, the WTRU may use as the Uu priority, the highest priority, if the SL RLC channel is configured with an indication to use the highest priority, and may use the lowest priority otherwise.

In another embodiment related to the above, the WTRU may use measurements on SL and/or Uu to further determine whether/how direct comparison is used. For example, the WTRU may use direct comparison for some value(s) of CBR (e.g., CBR below a threshold). For the case when CBR is above a threshold, the WTRU may use a different priority (or apply an offset to the priority) for the relayed data and/or not use direct priority comparison, but rather use comparison based on different thresholds and compare using the configured SL RLC priority and Uu RLC priority values.

### EXAMPLE EMBODIMENTS

In one example embodiment, an SL relay WTRU may determine whether to prioritize UL or SL transmissions based on whether the SL transmission is relayed Uu traffic, and if so, may perform comparison of the UL priority with either the highest priority or lowest priority Uu RLC channel mapped to the SL RLC channel in the adaptation layer. Specifically, a SL relay WTRU may determine that it cannot transmit SL and UL simultaneously. Such WTRU may transmit either SL or UL depending on whether SL or UL is prioritized. If SL transmission corresponds to a L2 destination of a remote WTRU receiving SL traffic, or if it contains LCHs associated with Uu relayed traffic to a remote WTRU, the relay WTRU may derive a priority (different from the SL RLC channel priority) for comparison with the Uu traffic priority. In such case, the SL transmission priority may be determined as the priority level of either the maximum or minimum priority Uu RLC channel that is mapped by the adaptation layer to the maximum SL RLC channel priority included in the SL transmission. If the SL RLC channel priority is above a threshold, the maximum is used. If the SL RLC channel priority is below or equal to the threshold, the minimum is used.

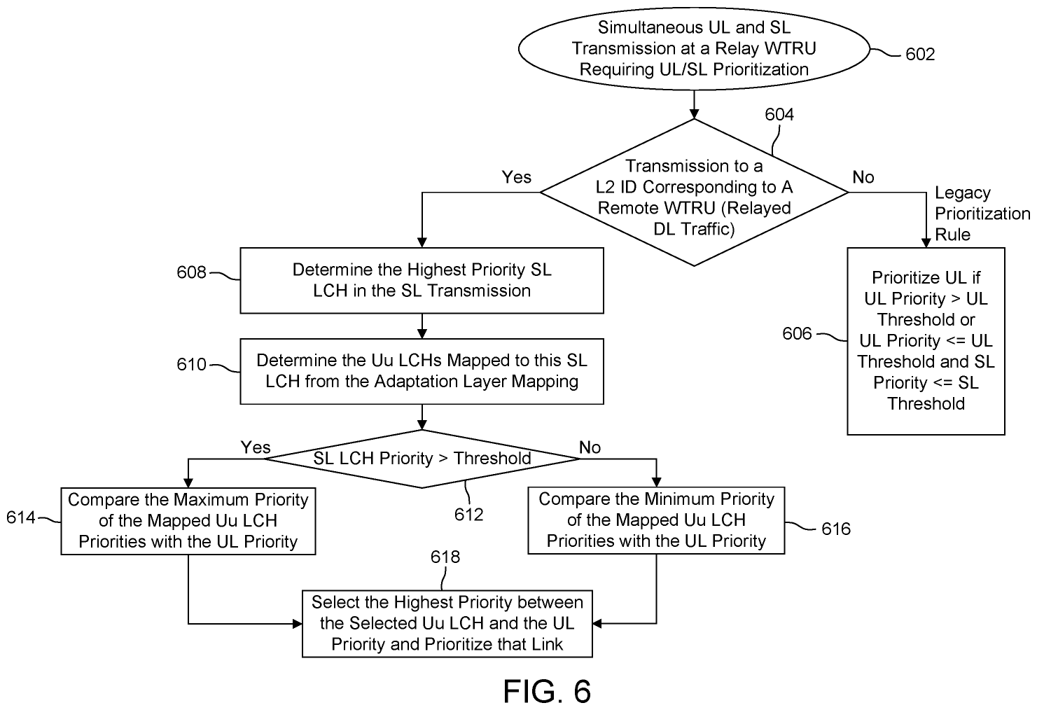

FIG. 6 is a flowchart illustrating such an embodiment. At 602, a relay WTRU simultaneously receives UL and SL transmissions requiring prioritization to decide which transmission to transmit. At 604, the relay WTRU determines if the SL transmission corresponds to a L2 destination of a remote WTRU. If not, then flow proceeds to step 606 where the relay WTRU prioritizes the UL transmission if either (a) the priority of the UL transmission is greater than a first, UL threshold or (b) the priority of the UL transmission is less than or equal to the first threshold and the priority of the SL transmission is less than a second, SL threshold.

If, on the other hand, in step 604, it is determined that SL transmission corresponds to a L2 destination of a remote WTRU, flow proceeds to step 608. In step 608, the relay WTRU determines the highest priority SL LCH in the SL transmission.

Next, in step 610, the relay WTRU determines the Uu LCH mapped to this SL LCH from the adaptation layer mapping.

Next, in step 612, the relay WTRU determines whether the SL LCH priority is above another threshold. If it is above the threshold, then, flow proceeds to step 614, in which the relay WTRU compares the priority level of the highest priority mapped Uu LCH to the UL priority determined in step 610. If it is not above the threshold, then flow instead proceeds to step 616, in which the relay WTRU compares the priority level of the lowest priority mapped Uu LCH to the UL priority.

Finally, flow proceeds from either step 614 or step 616 to step 618, where the relay WTRU selects the one of UL transmission and the SL transmission which had the higher assigned priority in the comparison step (614 or 616).

### Examples of Methods for Transmission of BSR in Relaying Scenarios.

### WTRU Determines Whether to Report SL/Uu BSR.

In relaying scenarios, transmission of SL/Uu BSR may be unnecessary, as the network may be aware of the WTRU's buffer status from knowledge of such from the previous link. A WTRU may determine whether to report SL/Uu BSR based on one or a combination of any of the factors below. Determining whether to report SL/Uu BSR may comprise determining any of the following condition: whether or not SL/Uu BSR is triggered at the WTRU, which logical channels will trigger/not trigger SL/Uu BSR, whether to include the data received from a LCH in the SL/Uu BSR, how much of the data (e.g., portion, percentage) to include in the SL/Uu BSR, and which ingress RLC channels mapped to the same egress RLC channel should contribute to the data reported in the SL/Uu BSR

Example Based on LCH Configuration and/or L2 ID.

In one embodiment, a WTRU may be configured with a subset of LCHs for which BSR (SL or UL) should be reported, and another subset of LCHs for which BSR should not be reported. Similarly, a WTRU may be configured with a L2 destination ID for which SL BSR should be reported or not reported. For example, a SL relay WTRU may report SL BSR for SL logical channels/L2 destination IDs that carry SL traffic, but not report SL BSR for SL logical channels/L2 destination IDs that carry Uu traffic (i.e., DL relayed traffic). In another example, a SL relay WTRU may be configured with SL logical channels for which SL BSR is reported/triggered or not reported/triggered (e.g., in the LCH configuration provided by the network). For example, a SL relay WTRU may be configured to report/trigger SL BSR only for SL LCHs/destination IDs of an RLC bearer that do not have an adaptation layer (i.e., for WTRU to network relaying) associated with them.

### Example Based on the Cell ID/Coverage/Allocation Mode of a Previous Hop(s).

In one embodiment, a relay WTRU may determine whether to report/trigger SL BSR based on the cell ID and/or allocation mode associated with a previous hop WTRU, possibly in comparison with the relay WTRU's own cell ID and/or allocation mode. Specifically, for example, a first WTRU (relay or remote) may send to a second WTRU (relay) the cell ID of the cell to which it is connected and/or the WTRU's SL allocation mode (mode 1 or mode 2). Alternatively, the first WTRU may send to the second WTRU the cell ID of the cell to which it is connected only when it is configured to operate in mode 1 with that cell, and may not send any cell ID when it is configured to operate in mode 2, or is OOC (Out of Coverage). Such information may be sent via a MAC CE, SCI, or PC5-RRC message, for example. The second (relay) WTRU (operating in mode 1 SL transmission, or relaying received data to the network via Uu) may determine, when relaying data from the first WTRU, whether to trigger SL/Uu BSR based on the cell ID received from the first WTRU, and the cell ID of the cell to which the second WTRU is connected. Specifically, if the second WTRU is connected to the same cell that received data from the first WTRU, the second WTRU may not report BSR, but, if connected to a different cell, the second WTRU may report BSR. “Same cell” may consist of the same cell ID, or an equivalent cell ID, for example, configured by the network.

In a related embodiment applicable to a multihop (more than 2 hops) scenario, the first WTRU in the above embodiment may send the cell ID information and/or allocation mode of multiple/all hops along the path between the source and destination WTRU(s)/gNB(s). Specifically, a first WTRU may send its own cell ID and/or allocation mode, as well as the cell ID and/or allocation mode of the attached WTRUs. A second WTRU may send the same information received from the first WTRU, as well as its own the cell ID and/or allocation mode, to a third WTRU, and so on. At a specific WTRU, whether to report/trigger BSR for data to be transmitted/relayed by that WTRU may further depend on the information received from a previous WTRU. For example, a WTRU may report/trigger (SL or UL) BSR for a LCH according to any of the following conditions: at least one of the previous-hop WTRUs has a cell ID that does not match the said WTRU's cell ID, at least one of the previous-hop WTRUs has mode 2 as its resource allocation mode, all of the previous-hop WTRUs have a cell ID that is different than the said WTRU's cell ID, and all of the previous-hop WTRUs have mode 2 as their resource allocation modes.

Without loss of generality, the previous hop may have been a gNB, where the cell ID in such case is the actual cell ID of the gNB. Specifically, a relay WTRU may not report/trigger BSR for a LCH if a previous hop is a gNB and the cell ID of the gNB is the same as the cell ID to which the said WTRU is connected.

### Example Based on Whether the LCH Carries Relayed or Non-Relayed Data.

In one embodiment, the decision of whether to trigger/report BSR may depend on whether the LCH carried relayed or non-relayed data. Specifically, a WTRU may report BSR if the LCH carries non-relayed data (i.e., data received from upper layers at the WTRU, and not data received from another WTRU).

### Example Based on Mapping of Ingress to Egress LCHs at the Adaptation Layer of WTRU.

In one embodiment, the decision of whether to trigger/report BSR may depend on specific rules related to the mapping of ingress to egress LCHs at the WTRU and/or WTRUs in previous hops (for multihop scenarios).

For example, a WTRU may trigger/report BSR for an egress LCH if there are more than one ingress LCHs mapped to the egress LCH. Further conditions described herein may also be used to make such determination based on any/all of the egress LCHs mapped to the ingress LCH.

In another example, a WTRU may trigger/report BSR for an egress LCH if any/all of the ingress LCHs mapped to that egress LCH is mapped to only that single egress LCH.

Any combination (and, or) of the above conditions also may be used for determining whether to trigger/report BSR. For example, the WTRU may/may not trigger/report BSR as long as a LCH satisfies multiple conditions simultaneously, and, otherwise, the WTRU may not/may trigger/report BSR.

In one embodiment, a WTRU may report the amount of data discarded/dropped from one or more LCHs. Such a report may be made to the gNB, for example, to inform the gNB that the WTRU has discarded/dropped an amount of data and that the gNB can schedule (as a consequence) an amount of data that is less than initially known by the gNB. Alternatively, a WTRU may report the amount of data discarded/dropped from one or more LCHs to a peer WTRU (e.g., a next hop WTRU) so that the peer WTRU can use this information in its own computation of BSR and/or in its own generation of such a report to the network.

In one example, a WTRU may report (e.g., via a MAC CE) the amount of data discarded by the WTRU for each logical channel or group of logical channels. Such report may be triggered by the WTRU upon dropping of one or more PDUs (e.g., due to not meeting latency requirements). Alternatively, such report may be triggered when the WTRU drops a certain amount (e.g., percentage) of data, possibly over a time period. For example, such report may be triggered by the WTRU when the amount of data dropped by the WTRU over a configured time period exceeds a configured threshold. Alternatively, such report may be triggered only when the WTRU drops data for a specific logical channel or logical channel group. For example, each LCH may be configured to enable/disable reporting of dropped data when data is dropped by the WTRU for that LCH.

### Examples of Methods for SL Transmission Parameter Selection.

### Selection of PDB by the Relay/Remote WTRU.

In one embodiment, a relay WTRU or remote WTRU may be configured (e.g., by the network) with multiple values of PDB associated with a single RLC channel and/or QoS flow. A WTRU may further be configured with an association between a PDB and a factor for PDB selection, as described below. A WTRU may select one of the configured values of PDB (e.g., for determining the value of T2 in resource selection) based on any of the following associated factors: network indication, number of retransmissions required, SL measurements by the relay/remote WTRU, Uu quality/RSRP measurements, and flow control messages.

For network indication factor, in one embodiment, the relay WTRU or remote WTRU may receive an indication (e.g., in DCI, associated with the DCI type, MAC CE, adaptation layer header, or similar) of the PDB to be used on a SL RLC channel. For example, the relay WTRU may select the PDB based on the DCI type used to schedule DL transmissions for Uu RLC channel(s) that are mapped to the corresponding SL RLC channel to which the PDB selection is applicable.

For a number of retransmissions required factor, in one embodiment, the relay WTRU or remote WTRU may select the PDB based on the number of retransmissions required at the WTRU (either on Uu or on sidelink) to successfully receive a PDU on that link. The number of retransmissions may comprise an average number of retransmissions required for successful reception at the WTRU, possibly associated with data that may be mapped to the RLC channel to which PDB selection is required. Alternatively, the number of retransmissions may be the value associated with the last reception of a PDU on a channel that can be mapped to the RLC channel on which PDB selection is required.

For SL measurements by the relay/remote WTRU factor (either measured by the relay/remote WTRU itself, or indicated to the relay/remote WTRU by the peer WTRU), in one embodiment, the relay or remote WTRU may be configured with a mapping of SL measurement to PDB selection, and may select the PDB based on the determined measurements. Such measurement may comprise any of: a CBR measurement measured at the WTRU itself, a CBR measurement provided by the peer WTRU (e.g., in a discovery message or dedicated PC5 RRC), a SL RSRP measurement made at the WTRU itself, a SL RSRP measurement received from the peer WTRU, a SL CQI measurements made by the WTRU itself, and a SL CQI measurements received from the peer WTRU.

For Uu quality/RSRP measurements factor, in one embodiment, the relay WTRU may determine the PDB to be used on SL based on the Uu quality measured at the relay WTRU. Such measurements may, for example, be measurements of CQI, RSRP, etc. associated with the Uu link at the relay WTRU. In another embodiment, the relay WTRU may provide Uu quality measurements or measurement indications to the remote WTRU. The remote WTRU may determine the PDB to be used on SL based on the received measurements or measurement indications.

For flow control messages factor, in one embodiment, the remote WTRU may determine the PDB based on reception of one or more flow control messages from the relay WTRU indicating the load/delay in relaying at the relay WTRU. In one example, the remote WTRU may select a first PDB when no flow control messages have been received, and may select a second PDB upon reception of a flow control, possibly within a configured time window. In another example, the remote WTRU may select a PDB that is associated with the load of a specific RLC channel included in a flow control message from the relay WTRU. In another example, the remote WTRU may select a PDB associated with the number of flow control messages received over a configured time window. In certain embodiments, only those flow control messages where the load associated with a particular RLC channel is above a threshold may be counted.

While the above discussion focus on determination of the SL portion of the PDB for resource selection purposes, the same techniques may be used for determination of the Uu portion of the PDB (for example, for discarding data that exceeds the PDB on Uu).

### Examples of Methods for Satisfying Packet Error Rate.

Example of WTRU Selecting the Reliability Parameters from a Configured Value of PER.

In one embodiment, a WTRU may receive a packet error rate (PER) value or similar reliability value associated with a transmission, LCH, destination, or the like. Such value may be applicable to transmission over sidelink for the purposes of relaying, for example. A WTRU may receive such value as part of the SL LCH configuration from the gNB. The WTRU may further receive such value as QoS information included in actual transmission (e.g., from the gNB for a WTRU to network relay). This can be included in the adaptation layer header or similar protocol header. Such also may be included in a control channel (e.g., in DCI associated with the DL transmission, or SCI associated with the sidelink transmission).

A WTRU may select a reliability factor associated with a transmission based on the transmission's PER value, and apply such reliability factor to the transmissions that have such PER value. The possible reliability factors may indicate any of the following information: whether to perform duplication on SL, possibly associated with different SL carriers, and whether to transmit HARQ enabled or HARQ disabled transmissions on SL. In addition, the reliability factors may comprise any of the following: a maximum/minimum number of SL carriers that can be used for resource selection and/or duplication of a transmission, a maximum/minimum number of SL retransmissions allowable for the data, a sensing type that the WTRU is allowed to use, a resource pool(s) that the WTRU is allowed to select from and an allowable partial sensing parameters that can be used for transmission associated with such PER. Other reliability factors are not excluded.

For example, the sensing type (e.g., random selection versus sensing based resource selection) can be configured with an allowable PER or range of PER values. For example, the resource pool(s) can be configured with an allowable PER or range of PER values. For example, the WTRU can be configured with a set or restriction of the partial sensing parameters for a given PER value or range of values

A WTRU may receive a configuration, e.g., in dedicated RRC signaling or SIB (System Information Block), or the allowable reliability factor(s) for a given PER or range of PERs. Alternatively, the allowable reliability factors can be predefined for each PER value or range of PER values.

In one embodiment, a LCH configured with a PER value (or range) may be used as part of an LCP restriction for transmission. Specifically, the WTRU may select for including data into a grant (e.g., a SL grant) only the LCHs for which the PER is within a range, where such range may be configured by the network.

In one example, a WTRU in mode 1 may be configured with an allowable PER range for a specific grant (e.g., in DCI or RRC for configured grants). The WTRU, when performing LCP for that grant, may include only LCHs for which the configured PER falls in the PER range for the specific grant. The PER range may be given explicitly, or may be derived by the WTRU as a range above/below/around a PER value indicated by the network (e.g., in DCI).

In another example, a WTRU may select a first logical channel (e.g., SL LCH) for inclusion into a grant. Following such selection, the WTRU may restrict selection of additional logical channels to a range determined by the first selected logical channel. Such range may be (pre)configured in size (PER value) around the selected PER value/range of the initially selected logical channel.

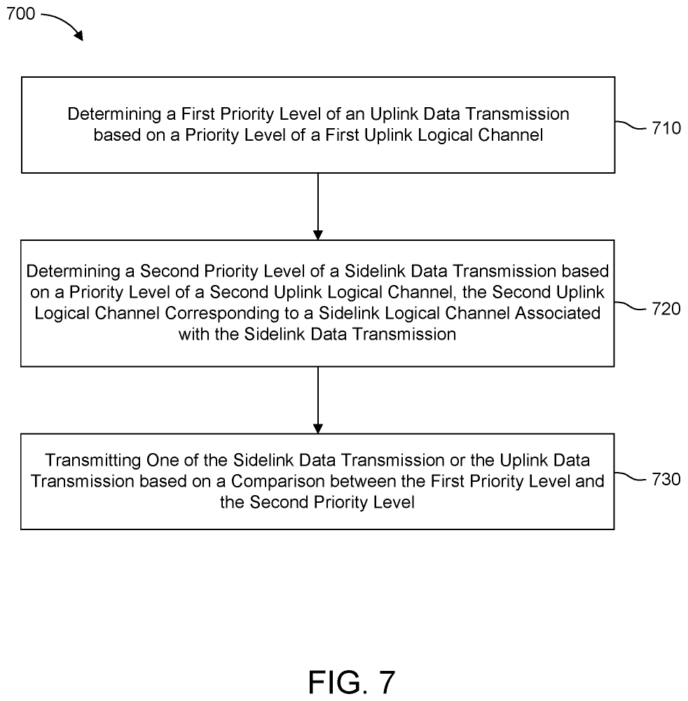

Referring to FIG. 7, a method 700 implemented in a WTRU, for determining whether to prioritize an uplink transmission or a sidelink transmission, may comprise a step of determining 710 a first priority level of an uplink data transmission based on a priority level of a first uplink logical channel.

The method may comprise a step of determining 720 a second priority level of a sidelink data transmission based on a priority level of a second uplink logical channel, the second uplink logical channel corresponding to a sidelink logical channel associated with the sidelink data transmission. The second uplink logical channel may map, from an adaptation layer mapping of the WTRU, to the sidelink logical channel associated with the sidelink data transmission. The determination of the priority level of the second uplink logical channel, may comprise a stesp of determining one or more uplink logical channels associated with the sidelink logical channel; and determining the priority level of the second uplink logical channel based on the determined one or more uplink logical channels.

The method may comprise a step of transmitting 730 one of the sidelink data transmission or the uplink data transmission based on a comparison between the first priority level and the second priority level. The comparison may be a direct comparison.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein, are provided below with respect to FIGS. 1A-1E.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. § 112, ¶6, and any claim without the word “means” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

The following references may have been referred to hereinabove and are incorporated in full herein by reference.
RP-193253—New SID: Study on NR sidelink relay
3GPP TS 36.300—TSGRAN E-UTRA and E-UTRAN Overall Description Stage 2 (V15.4.0)
3GPP TR 36.746—Study on Further enhancements to LTE D2D, UE to network relays for IoT and Wearables (V15.1.1)
3GPP TS 38.300—NR and NG-RAN Overall Description Stage 2 (V16.1.1)

1. A method implemented in a wireless transmit/receive unit (WTRU) comprising:
determining a first priority level of an uplink data transmission based on a second priority level of a first uplink logical channel;
determining one or more uplink logical channels mapped to a sidelink logical channel;
determining a third priority level of a second uplink logical channel based on respective priority levels of the one or more uplink logical channel;
determining a fourth priority level of a sidelink data transmission associated with the sidelink logical channel based on the third priority level, wherein the second uplink logical channel corresponds to the sidelink logical channel; and
transmitting the sidelink data transmission or the uplink data transmission based on a comparison between the first priority level and the fourth priority level.

2. (canceled)

3. The method of claim 1, wherein the third priority level corresponds to a maximum priority level or a minimum priority level among the respective priority levels of the one or more uplink logical channels.

4. The method of claim 3, wherein,
on condition that a priority level of the sidelink logical channel being above a sidelink threshold, the third priority level corresponds to the maximum priority level among the respective priority levels of the one or more uplink logical channels.

5. The method of claim 3, wherein,
on condition that a priority level of the sidelink logical channel being below a sidelink threshold, the third priority level corresponds to the minimum priority level among the respective priority levels of the one or more uplink logical channels.

6. The method according to claim 1, comprising determining that the uplink data transmission would overlap in time with the sidelink data transmission.

7. The method according to claim 1, comprising determining that the sidelink data transmission corresponds to a layer two destination of a remote WTRU.

8. The method according to claim 1, wherein the sidelink logical channel is: (1) a highest priority sidelink logical channel in the sidelink data transmission; or (2) a lowest priority sidelink logical channel in the sidelink data transmission.

9. The method according to claim 1, wherein transmitting the sidelink data transmission or the uplink data transmission comprises transmitting the one which has a higher priority level.

10. (canceled)

11. The method according to claim 1, wherein the second uplink logical channel maps, from an adaptation layer mapping of the WTRU, to the sidelink logical channel associated with the sidelink data transmission.

12. The method according to claim 1, wherein the second uplink logical channel comprises a quality of service requirement that maps to the sidelink logical channel associated with the sidelink data transmission.

13. A wireless transmit/receive unit (WTRU) comprising a processor, a transmitter, a receiver and memory, and configured to:
determine a first priority level of an uplink data transmission based on a second priority level of a first uplink logical channel;
determine one or more uplink logical channels mapped to a sidelink logical channel;
determine a third priority level of a second uplink logical channel based on respective priority levels of the one or more uplink logical channel;
determine a fourth priority level of a sidelink data transmission associated with the sidelink logical channel based on the third priority level, wherein the second uplink logical channel corresponds to the sidelink logical channel; and
transmit the sidelink data transmission or the uplink data transmission based on a comparison between the first priority level and the fourth priority level.

14. (canceled)

15. The WTRU of claim 13, wherein the third priority level corresponds to a maximum priority level or a minimum priority level among the respective priority levels of the one or more uplink logical channels.

16. The WTRU of claim 15, wherein, on condition that a priority level of the sidelink logical channel being above a sidelink threshold, the third priority level corresponds to the maximum priority level among the respective priority levels of the one or more uplink logical channels.

17. The WTRU of claim 15, wherein, on condition that a priority level of the sidelink logical channel being below a sidelink threshold, the third priority level corresponds to the minimum priority level among the respective priority levels of the one or more uplink logical channels.

18. The WTRU according to claim 13, configured to determine that the uplink data transmission would overlap in time with the sidelink data transmission.

19. The WTRU according to claim 13, configured to determine that the sidelink data transmission corresponds to a layer two destination of a remote WTRU.

20. The WTRU according to claim 13, wherein the sidelink logical channel is: (1) a highest priority sidelink logical channel in the sidelink data transmission; or (2) a lowest priority sidelink logical channel in the sidelink data transmission.

21. The WTRU according to claim 13, wherein transmit the sidelink data transmission or the uplink data transmission comprises transmit the one which has a higher priority level.

22. (canceled)

23. The WTRU according to claim 13, wherein the second uplink logical channel maps, from an adaptation layer mapping of the WTRU, to the sidelink logical channel associated with the sidelink data transmission.

24. The WTRU according to claim 13, wherein the second uplink logical channel comprises a quality of service requirement that maps to the sidelink logical channel associated with the sidelink data transmission.
